(19) United States
(12) Patent Application Publication
(10) Pub. No.: US 2012/0027353 A1
(43) Pub. Date: Feb. 2, 2012

(54) OPTICAL FIBER CONNECTOR AND METHOD FOR MAKING SAME

(75) Inventor: I-THUN LIN, Tu-Cheng (TW)

(73) Assignee: HON HAI PRECISION INDUSTRY CO., LTD., Tu-Cheng (TW)

(21) Appl. No.: 12/947,810

(22) Filed: Nov. 16, 2010

(30) Foreign Application Priority Data
Jul. 29, 2010 (TW) 99125015

(51) Int. Cl. G02B 6/36; G02B 6/26

(52) U.S. Cl. 385/53; 264/1.25

(57) ABSTRACT

An optical fiber connector includes an optical fiber coupling portion and an optical element portion attached to the optical fiber coupling portion. The optical fiber coupling portion includes a first engaging surface and a through hole exposed at the first engaging surface. The through hole receives an optical fiber. The optical element portion includes a second engaging surface engaged with the first engaging surface and a lens portion aligned with a central axis of the through hole. A method for making the optical fiber connector is also provided.

### BACKGROUND

1. Technical Field

The present disclosure relates to an optical fiber connector, and a method for making the optical fiber connector.

2. Description of Related Art

Optical fiber connectors are widely used in optical fiber communications. The optical fiber connectors connect optical fibers, or connect optical fibers with other devices.

A typical optical fiber connector includes an optical fiber coupling portion and an optical element portion integrally formed with the optical fiber coupling portion. The optical fiber coupling portion has blind optical fiber holes for receiving optical fibers. However, with the above configuration, it is difficult to control coarseness of the bottom of the blind optical fiber holes which may cause light loss in the optical fiber communication.

In addition, as the optical element portion is integrally formed with the optical fiber coupling portion, the optical element portion and the optical fiber coupling portion are usually made from the same material which is difficult to meet the respective requirements of the optical element portion and the optical fiber coupling portion. For example, the optical element portion usually requires a high strength and a high light transmittability, and materials with these characteristics usually have low flowability which cannot meet requirements of the optical fiber coupling portion.

What is needed, therefore, is an optical fiber connector and a method for making same, which can overcome the above shortcomings.

### BRIEF DESCRIPTION OF THE DRAWINGS

Many aspects of the present optical fiber connector and method can be better understood with reference to the following drawings. The components in the drawings are not necessarily drawn to scale, the emphasis instead being placed upon clearly illustrating the principles of the present optical fiber connector and method. Moreover, in the drawings, like reference numerals designate corresponding parts throughout the several views.

FIG. 1 is an isometric view of an optical fiber connector in accordance with an embodiment.

FIG. 2 is an exploded view of the optical fiber connector of FIG. 1.

FIG. 3 is a cutaway view of the optical fiber connector of FIG. 1.

### DETAILED DESCRIPTION

Embodiments of the present optical fiber connector and method will now be described in detail below and with reference to the drawings.

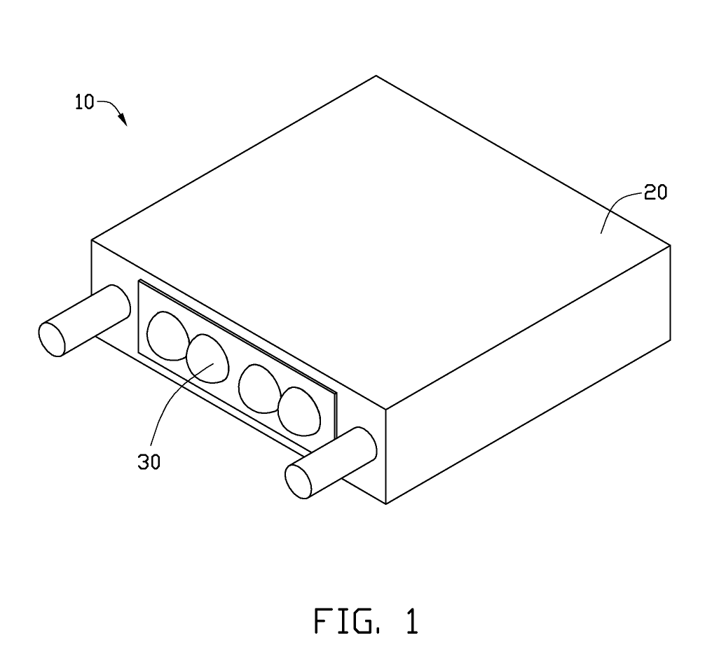

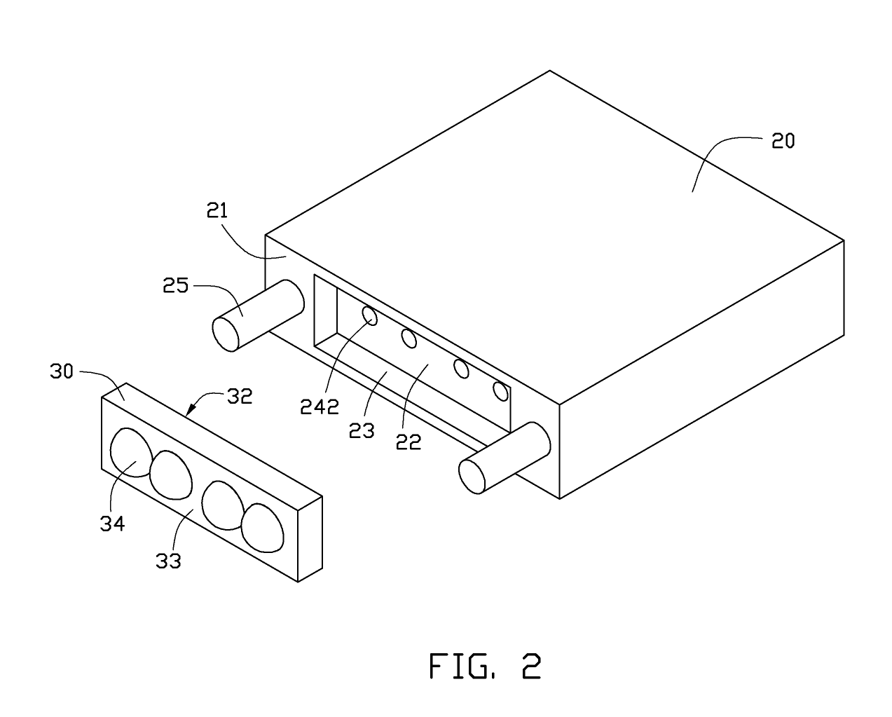

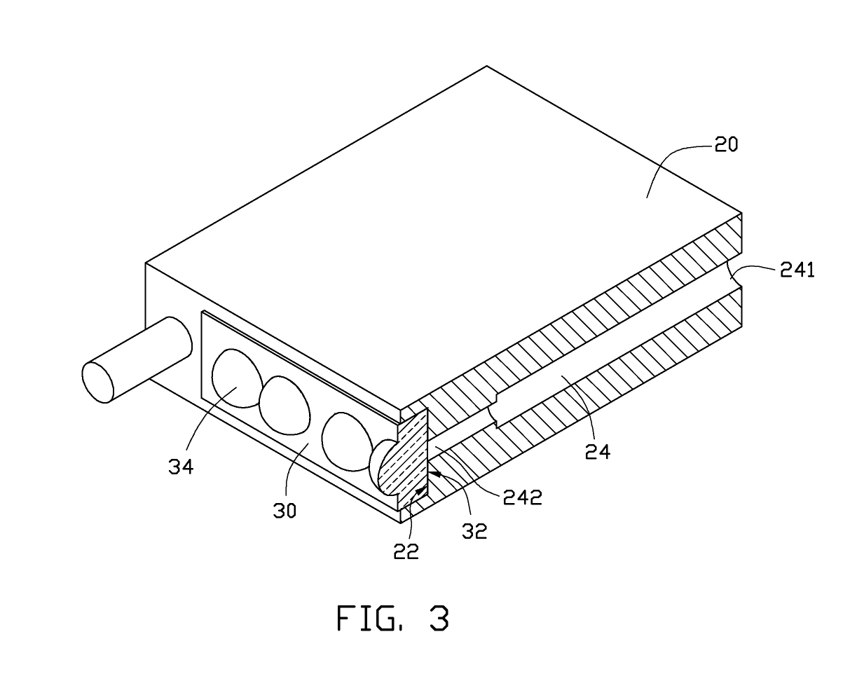

Referring to FIGS. 1 to 3, an optical fiber connector 10 includes an optical fiber coupling portion 20 and an optical element portion 30 coupled to the optical fiber coupling portion 20.

The optical fiber coupling portion 20 includes a first engaging surface 22 and at least one optical fiber hole 24. In the present embodiment, the optical fiber coupling portion 20 has a front surface 21, and a recess 23 formed in a central area of the front surface 21. The first engaging surface 22 is the bottom surface of the recess 23, and the first engaging surface 22 is parallel with the front surface 21. The optical fiber coupling portion 20 includes four optical fiber holes 24, and each of the optical fiber holes 24 is configured for receiving an optical fiber (not shown). Each of the optical fiber holes 24 is a through hole in the optical fiber coupling portion 20, and each of the optical fiber holes 24 has an entrance 241 located at a back surface of the optical fiber coupling portion 20, and an exit 242 located at the first engaging surface 22.

The optical element portion 30 includes a second engaging surface 32 and an outer surface 33 opposite to the second engaging surface 32. The outer surface 33 has a number of optical lens portions 34 formed thereon. The optical lens portions 34 each have a curved surface at the outer surface 33. In the present embodiment, the number of the optical lens portions 34 is the same with the number of the optical fiber holes 24. The entire optical element portion 30 is integrally formed. The entire optical element portion 30 can be made from a light-pervious material, or at least the optical lens portions 34 and the portions aligned with the optical lens portions 34 are made from the light-pervious material.

The optical element portion 30 is attached to the optical fiber coupling portion 20, with the optical element portion 30 being inserted in the recess 23, and the second engaging surface 32 being engaged with the first engaging surface 22. The outer surface 33 is flush with the front surface 21. In the present embodiment, both of the second engaging surface 32 and the first engaging surface 22 are flat surfaces. The second engaging surface 32 seals the exits 242 of the optical fiber holes 24 to make the optical fiber holes 24 blind. A central axis of each of the optical fiber hole 24 is aligned with an optical axis of one of the optical lens portions 34. The optical lens portions 34 each can receive a light from or guide a light to one of the optical fibers received in the optical fiber holes 24, and change light path as needed. In the present embodiment, the optical lens portions 34 are convex lenses. In other embodiments, the optical lens portions 34 can be concave lenses to reduce or avoid dust or other things falling thereon.

Relative to a conventional optical fiber connector, which is integrally formed, the combination of the optical fiber coupling portion 20 and the optical element portion 30 can avoid to make blind optical fiber holes. In addition, as the first engaging surface 22 and the second engaging surface 32 are end surfaces of the optical fiber coupling portion 20 and the optical element portion 30, therefore, the coarseness of the first engaging surface 22 and the second engaging surface 32 are easily to control and to be in time detected.

The front surface 21 of the optical fiber coupling portion 20 has two guide members 25 formed on opposite sides of the recess 23, and the guide members 25 guide the optical fiber connector 10 to couple to the other device (not shown). In the present embodiment, the guide members 25 are posts, and the other device to be coupled to the optical fiber connector 10 can have recesses formed therein. In other embodiments, the guide members 25 can be recesses, and the other device to be coupled to can have posts formed therein.

The optical fiber coupling portion 20 and the optical element portion 30 are separately made. A method for making the optical fiber connector 10 may include steps as follows.

First, a first mold for molding the optical fiber coupling portion 20 is provided, and a first molding material is fed into the first mold to form the optical fiber coupling portion 20. As the optical fiber coupling portion 20 has a larger size, the first molding material may be polymethyl methacrylate (PMMA) or polycarbonate (PC) for example, which has a high flowability to avoid a short shot and a blow hole during molding the optical fiber coupling portion 20.

Second, a second mold for molding the optical element portion 30 is provided, and a second molding material is fed into the second mold to form the optical element portion 30. The optical element portion 30 requires a high light transmittability, such that the second molding material may be a ULTEM resin for example, which has a high strength and a high light transmittability for a light with a specified wavelength.

As the optical fiber coupling portion 20 and the optical element portion 30 are separately made, the optical fiber coupling portion 20 and the optical element portion 30 can be made from different materials detailed above. Relative to the second material, a melting point of the first material can be lower than that of the second material, and a flowability of the first material is higher than that of the second material.

In addition, the optical fiber coupling portion 20 and the optical element portion 30 can be made by different molding methods, for example, both the optical fiber coupling portion 20 and the optical element portion 30 can be made by injection molding, alternatively, the optical fiber coupling portion 20 is made by injection molding, and the optical element portion 20 can be made by press-molding.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An optical fiber connector, comprising:
an optical fiber coupling portion comprising a first engaging surface and a through hole exposed at the first engaging surface, the through hole configured for receiving an optical fiber; and
an optical element portion attached to the optical fiber coupling portion, the optical element portion comprising a second engaging surface engaged with the first engaging surface and a lens portion aligned with a central axis of the through hole.

2. The optical fiber connector of claim 1, wherein the optical fiber coupling portion is made from a first molding material and the optical element portion is made from a second molding material, a melting point of the first molding material is lower than that of the second molding material, and a flowability of the first molding material is higher than that of the second molding material.

3. The optical fiber connector of claim 1, wherein the first engaging surface and the second engaging surface are flat surfaces.

4. The optical fiber connector of claim 3, wherein the optical element portion is comprised of a light-pervious material.

5. The optical fiber connector of claim 1, wherein the optical fiber coupling portion comprises a recess with the first engaging surface located at a bottom of the recess, and the optical element portion is engagingly received in the recess.

6. The optical fiber connector of claim 5, wherein the optical fiber coupling portion comprises two guiding members at opposite sides of the recess.

7. A method for making an optical fiber connector, the method comprising:
forming an optical fiber coupling portion using a first mold, the optical fiber coupling portion comprising a first engaging surface and a through hole exposed at the first engaging surface;
forming an optical element portion using a second mold, the optical element portion comprising a second engaging surface and an optical lens;
attaching the optical element portion to the optical fiber coupling portion with the second engaging surface engaging with the first engaging surface, and an optical axis of the optical lens aligned with a central axis of the through hole.

8. The method of claim 7, wherein the optical fiber coupling portion is made from a first molding material and the optical element portion is made from a second molding material, a melting point of the first molding material is lower than that of the second molding material, and a flowability of the first molding material is higher than that of the second molding material.

9. An optical fiber connector, comprising:
an optical fiber coupling portion comprising a first surface and a plurality of through holes exposed at the first engaging surface;
a plurality of optical fibers received in the respective through holes; and
a light pervious block attached to the optical fiber coupling portion, the light pervious block comprising a second surface interfacing with the first surface, the light pervious block comprising a plurality of optical lens portions aligned with the respective through holes.

10. The optical fiber connector of claim 9, wherein the second surface is a flat surface.

11. The optical fiber connector of claim 10, wherein each of the optical lens portions includes a curved surface at an opposite sides of the flat second surface.

12. The optical fiber connector of claim 9, wherein the optical fiber coupling portion is formed of a first molding material and the light pervious block is formed of a second molding material, a melting point of the first molding material is lower than that of the second molding material, and a flowability of the first molding material is higher than that of the second molding material.
